(19) United States
(12) Patent Application Publication
(10) Pub. No.: US 2006/0108971 A1
(43) Pub. Date: May 25, 2006

(54) Method and apparatus for managing state of in-vehicle battery

(75) Inventor: Hiroaki Ono, Tokoname-shi (JP)

Correspondence Address: OLIFF & BERRIDGE, PLC, P.O. BOX 19928, ALEXANDRIA, VA, 22320, US

(73) Assignee: DENSO CORPORATION, Kariya-shi (JP)

(21) Appl. No.: 11/280,178

(22) Filed: Nov. 17, 2005

(30) Foreign Application Priority Data
Nov. 19, 2004 (JP) 2004-336457

(51) Int. Cl. H02J 7/00

(52) U.S. Cl. 320/104

(57) ABSTRACT

A vehicle power unit comprises an engine managing circuit for detecting an engine start battery state quantity, which is an electrical quantity associated with in-vehicle battery conditions at engine start, and for determining in-vehicle battery conditions based on the detected engine start battery state quantity. Based on detected or inputted information, the engine managing circuit determines whether or not an in-vehicle battery has been exchanged. If the in-vehicle battery is determined as having been exchanged, a predetermined engine start prompting operation is performed as a control operation for prompting engine start after the exchange. The control operation includes giving a warning for prompting a driver's engine start operation after detecting battery exchange, and performing automatic engine start if engine start is yet to be performed. After performing the engine start, the voltage and current of the in-vehicle battery are measured.

### CROSS-REFERENCE TO RELATED APPLICATION

This application is based on and claims the benefit of priority from earlier Japanese Patent Application No. 2004-336457 filed on Nov. 19, 2004, the description of which is incorporated herein by reference.

### BACKGROUND OF THE INVENTION

1. Technical Field of the Invention

The present invention relates to a power unit for vehicle loading a secondary battery and a managing system for the secondary battery.

2. Related Art

Various systems are known for computing a residual capacity of a vehicle battery. For example, Japanese Published Unexamined Patent Application No. 2004-085574 discloses a current integration system for detecting and integrating charge and discharge current of a battery. Such an integration system is superior in the accuracy to the one utilizing battery voltage, and is widely used as a residual capacity (SOC: State of Charge) computing system. However, this current integration system accumulates integration errors, necessitating to periodically renew a residual capacity (SOC). Various techniques for such a renewal are known as disclosed, for example, in Japanese Published Unexamined Patent Application No. 2004-093551.

In residual capacity determining systems other than the current integration systems, it is quite beneficial to use a battery voltage of a case where a battery open voltage, i.e. charge and discharge current, is “0”. In this case, time delay voltage components, such as battery polarization, affect the battery open voltage. For this reason, a battery open voltage should preferably be obtained in a system in which such adverse effects are eliminated as much as possible.

It is known that, at the time of starting engine with high current (not less than several hundreds amperes) in short time (less than one second), the effect of polarization voltage, which is included in battery voltage drop components, is small. Thus, it is also known that using a data pair consisting of a battery voltage and a starting current at engine start, is preferable in computing a residual capacity.

For example, an internal resistance of a battery (hereinafter, also referred to as a “battery resistance”) and a battery open voltage is obtained using a data group of battery voltage and battery current, including the data pair. There is known a system for determining a residual capacity, based on these battery resistance and battery open voltage (see, for example, Japanese Published Unexamined Patent Application No. 2004-093551). In this case, the effects of polarization voltage components among the voltage drop components in a battery are eliminated as much as possible in order to obtain an accurate battery resistance and a battery open voltage as described above. In this way, making an effort is required in raising a ratio of the resistance voltage drop components included in the voltage drop components in a battery. For this purpose, it is important, as described above, to extract the data pair consisting of a battery voltage and a starting current at engine start.

Further, a technique for determining a degree of battery deterioration based on a degree of resistance is also disclosed in the above-mentioned Japanese Published Unexamined Patent Application No. 2004-085574 or the like. In this case as well, extraction of the data pair consisting of a battery voltage and a starting current at engine start, plays quite an important role to avoid the effects of battery polarization voltage as much as possible for an accurate battery resistance.

As described above, a data pair, i.e. a battery voltage (engine start battery voltage) and starting current, is measured at the time of starting engine to determine a residual capacity and a degree of battery deterioration. Then, the deterioration degree and the residual capacity of a battery are determined using a V-I data pair set including the data pair at engine start. In this case, certain information is to be retained at least for use at the subsequent engine start. The certain information relates to the data pair at engine start, or the battery resistance or battery open voltage computed by using a battery state quantity at engine start, or the residual capacity of a battery or the deterioration degree of a battery computed by using the data pair or the battery resistance or the battery open voltage at engine start.

In vehicles, however, battery exchange is often required. In such a case, the past data pair at engine start or the battery information computed therefrom, is deleted if the information has been retained in a volatile memory. If the information has been retained in a non-volatile memory, the information turns out to be the one incompatible with the actual conditions of a battery after exchange.

As a result, from after the battery exchange up to the subsequent engine start to extract a data pair concerning the new battery, circumstances may be such that no data pair at engine start exists, or a false data pair at engine start is retained.

In such circumstances, a battery managing device and an engine ECU which cooperates with the device, may unavoidably operate with the recognition of an inaccurate or false residual capacity or deterioration degree of a battery to possibly cause an improper control operation.

### SUMMARY OF THE INVENTION

The present invention has been made in view of the disadvantage described above, and provides a vehicle power unit which is capable of well avoiding engine start failures.

In the present invention, as one aspect, there is an apparatus for managing a state of an in-vehicle battery including in a power supply for use in a vehicle in which an engine is mounted, comprising: determining means for determining whether or not the in-vehicle battery is exchanged to a new in-vehicle battery; and promoting means for performing a predetermined promoting operation promoting a start of the engine after exchanging the in-vehicle battery, in cases where it is determined that the in-vehicle battery has been exchanged.

Preferably, the apparatus further comprises detecting means for detecting a signal indicating the state of the in-vehicle battery when the engine is started; estimating means for estimating the state of the in-vehicle battery based on the detected electric signal; managing means for managing the state of the in-vehicle battery based on a result estimated by the estimating means.

According to the present invention, a battery state quantity at engine start can be promptly extracted because engine start is performed early after battery exchange. As a result, the disadvantage of disabling engine start such as by using a current consumer requiring no engine start in a condition of uncertain residual capacity of a battery, can be eliminated or reduced.

Note that a “battery state quantity at engine start”, i.e. an “electrical quantity related to in-vehicle battery conditions at engine start” referred to herein, preferably includes a data pair consisting of a battery voltage (engine start battery voltage) and a discharge current (starting current) at engine start. As described above, engine start is performed with high current (not less than several hundreds amperes) in short time (less than 1 second). Therefore, the effect of polarization voltage included in the voltage drop components in a battery is very small. Accordingly, such voltage drop components turn out to be excellent input data for accurately computing an internal resistance of a battery (battery resistance) and an open voltage of a battery, which are correlated to battery deterioration and a residual capacity.

Information on the necessity of battery exchange may be detected by a battery managing circuit, or may be manually inputted by a person who exchanges batteries.

Note that a “Predetermined prompting operation” for engine start is an operation for promptly performing engine start after battery exchange. This includes, for example, an optical or sonic warning or instructions, inhibition of operation of particular current consumers, and automatic engine start. However, performing automatic engine start requires safety measures.

A battery managing circuit of the present invention is applicable to management of not only secondary batteries of normal engine vehicles, but also to management of hybrid secondary batteries, and secondary batteries sub-loaded on fuel cell powered vehicles. In a fuel cell powered vehicle, however, high current discharge of a battery is not required for starting engine. Therefore, for substitution with the engine start described above, a technique may be used, for example, for driving a vehicle running motor while cutting off power transmission to wheels.

It is preferred that, in the apparatus described above, the determining means is configured to detect the exchange of the in-vehicle battery by detecting a condition where a battery voltage across the in-vehicle battery decreases lower than a predetermined threshold of the battery voltage, and the promoting means is configured to perform the promoting operation when the exchange of the in-vehicle is determined.

Thus, whether or not battery exchange has been carried out can be automatically determined by using quite a simple circuit, which enables omission of manual input of battery exchange information by a forgetful battery exchanger.

It is also preferred that apparatus further comprises calculating means for calculating a value corresponding to a battery resistance of the in-vehicle battery or a functional value whose variable is the battery resistance, based on the detected signal indicating the state of the in-vehicle battery when the engine is started; and deciding means for deciding a state showing a residual capacity or a deteriorated state of the in-vehicle battery using the calculated value. Thus, early and accurate determination on a battery residual capacity or a battery deterioration degree is enabled after battery exchange.

As another aspect, the present invention provides an apparatus for managing a state of an in-vehicle battery including in a power supply for use in a vehicle in which an engine is mounted, comprising: means for determining whether or not a residual capacity of the in-vehicle battery is lower than a predetermine level, on the basis of the state of the in-vehicle battery estimated when the engine is started; and means for performing a promoting operation for prolonging a predetermined operation of the engine when it is determined that the residual capacity of the in-vehicle battery is lower than a predetermine level.

According to the present invention, a battery residual capacity of high accuracy can be obtained from a battery state quantity at engine start. If the obtained residual capacity is less than an electric power required for the subsequent engine start, prolongation of engine operation is encouraged, so that a possible error at the subsequent engine start may be prevented.

Note that, herein, a “battery state quantity at engine start”, i.e. an “electrical quantity associated with in-vehicle battery conditions at engine start” preferably includes a data pair consisting of a battery voltage at engine start (engine start battery voltage) and a discharge current (starting current). As described above, engine start is carried out with high current (not less than several hundreds amperes) in short time (less than 1 second). Therefore, the effect of polarization voltage included in the voltage drop components in a battery, is very small. Accordingly, such voltage drop components turn out to be excellent input data for accurately computing an internal resistance of a battery (battery resistance) and an open voltage of a battery, which are correlated to battery deterioration and a residual capacity.

The “predetermined operation for encouraging engine operation prolongation” is an operation for inhibiting engine stop. For example, this operation includes an optical or sonic warning or instructions to a driver, and an automatic operation for prohibiting engine stop.

The battery managing circuit of the present invention is applicable to the management, such as of secondary batteries for normal engine vehicles, and hybrid secondary batteries.

In a preferred embodiment, if the deterioration of an in-vehicle battery is serious as determined at the time of starting engine on the basis of the results of the determination on the in-vehicle battery, the operation for encouraging engine operation prolongation is stopped. Thus, failure can be avoided, in which engine operation is prolonged when there is no expectation in the improvement of battery charge conditions by the prolongation. Note that, if the deterioration of an in-vehicle battery is serious as determined at the time of starting engine on the basis of the results of the determination on the in-vehicle battery, warning should preferably be given accordingly.

### BRIEF DESCRIPTION OF THE DRAWINGS

In the accompanying drawings:

FIG. 1 is a block circuit diagram illustrating a vehicle power unit according a first embodiment;

FIG. 2 is a flow diagram illustrating a battery managing operation performed by a battery managing circuit of FIG. 1;

FIG. 3 is a flow diagram illustrating a battery exchange detecting operation performed by the battery managing circuit of FIG. 1;

FIG. 4 is a flow diagram illustrating a battery exchange detecting operation performed by the battery managing circuit of FIG. 1;

FIG. 5 is a flow diagram illustrating an engine start prompting operation performed by the battery managing circuit of FIG. 1;

FIG. 6 is a flow diagram illustrating a battery condition detecting operation at the time of prompting engine start, performed by the battery managing circuit of FIG. 1; and

FIG. 7 is a flow diagram illustrating an operation at the time of executing a sleep mode, performed by the battery managing circuit of FIG. 1.

### DETAILED DESCRIPTION OF THE PREFERRED EMBODIMENTS

Hereinafter, a preferred embodiment of a vehicle power unit and a method for managing a secondary battery thereof according to the present invention, will now be described with reference to the accompanying drawings.

A vehicle power unit of the present embodiment is the one used for a vehicle having an engine, which covers running power by engine power alone. The vehicle power unit of the present invention may be applicable to the management of secondary batteries loaded not only on the vehicles having such engines, but also on hybrid vehicles.

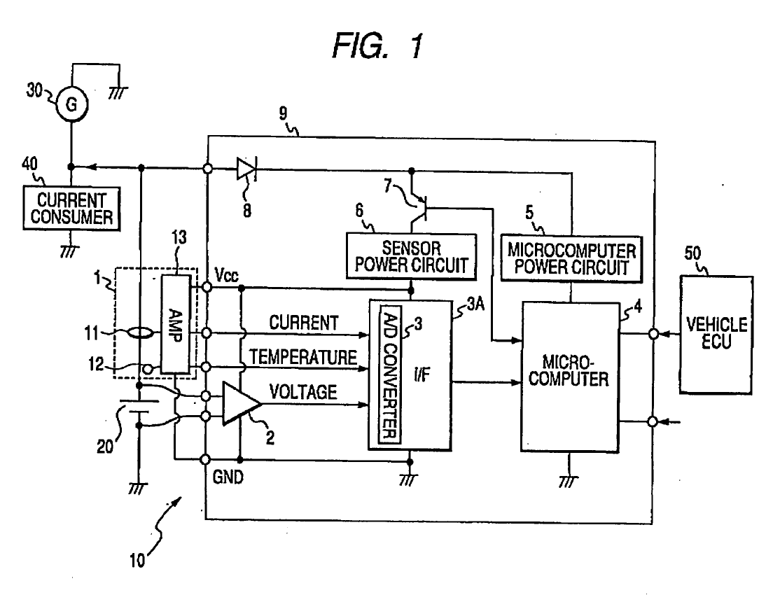

FIG. 1 is a block circuit diagram illustrating the vehicle power unit of the present embodiment.

As shown in FIG. 1, the vehicle power unit comprises a battery circuit 10 having a microcomputer 4, an in-vehicle battery 20 serving as a secondary battery, and a power generator 30. The power generator 30 and the in-vehicle battery 20 supply power to a vehicle current consumer 40. Since this type of vehicle power unit is well known per se, further description is omitted.

An electronic control unit (abbreviated as a vehicle ECU) 50 for controlling vehicle, which communicates with the microcomputer 4, is connected to the battery managing circuit 10. The vehicle ECU 50 cooperates with the microcomputer 4 to execute an engine start prompting operation, i.e. a control operation for prompting engine start after battery exchange, which constitutes one feature of the present embodiment. This prevents occurrences of malfunction, i.e. failure in subsequent engine start which may be caused, for example, by a procedure in which measurement of an engine start battery state quantity after battery exchange is performed later than a current supply to a current consumer.

The battery managing circuit 10 is provided with an external sensor 1 disposed on the side of the in-vehicle battery 20, and a single-chip microcomputer 9 disposed on an output side of the external sensor 1.

The external sensor 1 is provided with a current sensor 11 for detecting charge and discharge current of the in-vehicle battery 20, a temperature sensor 12 for detecting temperature of the in-vehicle battery 20, and an amplifier 13 for amplifying the output voltage of these sensors 11 and 12 to an analogue voltage of predetermined magnitude.

The single-chip microcomputer 9 can be manufactured, for example, by a BiCMOS semiconductor chip manufacturing technique. The single-chip microcomputer 9 is provided therein with a voltage detection circuit 2 which is connected across the terminals of the in-vehicle battery 20, an interface (I/F) circuit 3A including an A/D converter 3 which is connected to the output side of the amplifier 13, and the microcomputer 4 which is connected to the output side of the A/D converter 3. The A/D converter 3 and the microcomputer 4 are connected through a serial bus.

The voltage detection circuit 2, in the example of FIG. 1, consists of an operational amplifier for converting the voltage of the in-vehicle battery 20 into the analogue voltage of predetermined magnitude. The output voltage of the amplifier 13 and the voltage detection circuit 2 is chronologically converted into a digital signal by the A/D converter 3 so as to be read into the microcomputer 4 through the serial bus.

Further, the single-chip microcomputer 9 is provided therein with a diode 8 for blocking reverse current, whose anode side is connected to a positive electrode side of the in-vehicle battery 20, a sensor power circuit 6, which is connected to a cathode side of the diode 8 through a sensor side power blocking switch 7, and a microcomputer power circuit 5, which is connected to the cathode side of the diode 8.

In the example shown in FIG. 1, the sensor side power blocking switch 7 consists of a PNP type bipolar transistor serving as a switching element, with its emitter being connected to the cathode side of the diode 8, its collector being connected to the sensor power circuit 6, and its base being connected to the microcomputer 4. In response to a control signal from the microcomputer 4, the base current is controlled, by which the collector current is controlled for on/off control of the power supply to the sensor power circuit 6. Note that the switch 7 may not be limited to a PNP type bipolar transistor, but other switching elements, such as an NPN type bipolar transistor and an MOS field effect transistor (MOSFET) may also be applicable.

The in-vehicle battery 20 supplies power to the microcomputer power circuit 5 through the reverse current blocking diode 8, and also supplies power to the sensor power circuit 6 through the reverse current blocking diode 8 and the sensor side power blocking switch 7. The microcomputer power circuit 5 applies power supply voltage to the microcomputer 4, and the sensor power circuit 6 applies power supply voltage to the external sensor 1, the voltage detection circuit 2 and the A/D converter 3. The sensor power circuit 6 is designed with higher precision than the microcomputer power circuit 5.

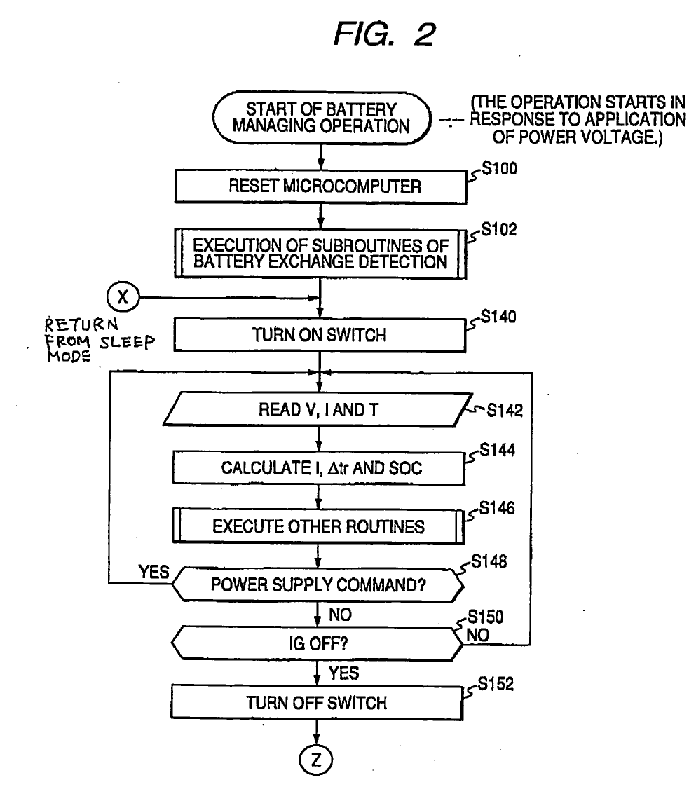

With reference to FIGS. 2 to 7, battery managing operations which are executed by the microcomputer 4 will now be described hereunder. The control programs corresponding to the flow diagrams illustrated in FIGS. 2 to 7 are stored in a memory (not shown), such as a ROM, of the microcomputer 4. A CPU (central processing unit: not shown) of the microcomputer 4 executes commands of the control programs, so that the battery managing operation is performed by the microcomputer 4.

As shown in FIG. 2, the battery managing operation starts with the application of the power supply voltage to the microcomputer 4. Specifically, when the voltage, i.e. battery voltage, of the in-vehicle battery 20 is applied to the microcomputer power circuit 5, a power supply voltage of 5V constant voltage is supplied to the microcomputer 4 from the microcomputer power circuit 5. As a result, individual portions in the microcomputer 4 are firstly reset (step S100), and then subroutines for battery exchange detection (step S102) is executed.

Further description is provided for the resetting. Similar to normal microcomputers, upon reapplication of the power supply voltage after interruption thereof, the microcomputer 4 initially performs a resetting step for resetting the internal data to initial values. This allows individual registers and volatile memories, such as a RAM, in the CPU to be initialized. As a matter of course, this also allows information of the past associated with the in-vehicle battery 20, which has been stored in the microcomputer 4, to be deleted. However, in the present embodiment, the in-vehicle battery 20 is to apply power supply voltage to the microcomputer power circuit 5, and the microcomputer power circuit 5 is to constantly apply power supply voltage to the microcomputer 4.

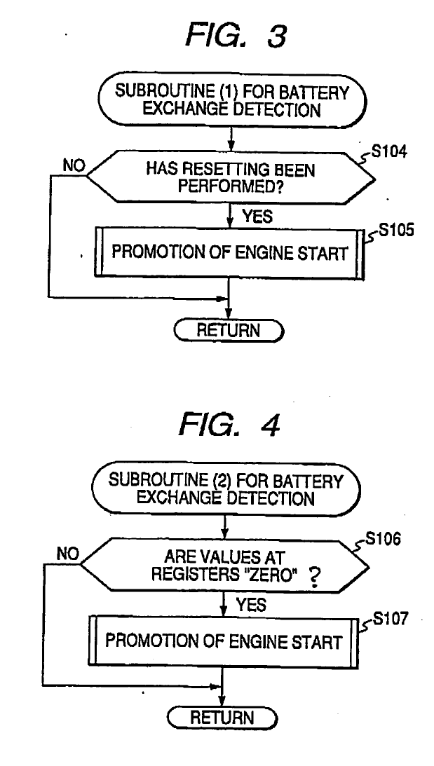

One example of a subroutine at step S102 for detecting battery exchange is described, with reference to the flow diagram illustrated in FIG. 3.

In battery exchange, an old battery is removed and a new battery is set up. By removing an old battery, application of power supply voltage from the microcomputer power circuit 5 to the microcomputer 4 is interrupted. When a new battery is connected thereafter, the microcomputer power circuit 5 resumes applying power supply voltage to the microcomputer 4.

Thus, it will be noted that, when battery is exchanged, the battery managing operation routine shown in FIG. 2 is started, and that resetting at step S100 is performed. In this regard, as shown in FIG. 3, a determination is made as to whether or not a resetting operation has been performed (step S104). If the resetting operation is determined to have been performed (YES), a battery exchange is recognized to have been carried out to execute an engine start prompting routine (step S105) as will be described later. On the other hand, if the resetting operation is determined not to have been performed at step S104 (NO), control is returned to the battery managing operation routine shown in FIG. 2. The remaining battery managing operation routine will be described later.

Another example of a battery exchange detecting subroutine is described with reference to the flow diagram illustrated in FIG. 4.

Among the individual registers or volatile memories in the microcomputer 4, the registers holding a battery voltage V are determined first as to whether or not their values are “zero” (step S106). In the present embodiment, when the resetting operation is performed at step S100, the values of the registers holding the battery voltage are reset to “zero”. This in turn enables determination as to whether or not a resetting operation has been performed, while also enabling detection of cases where the battery voltage V has become “zero” due to causes other than a resetting operation. Note that, instead of making a determination on the registers holding battery voltage, i.e. the registers holding the latest value of the battery voltage V, the registers holding a battery voltage at engine start may be determined as to whether or not their values are “zero”.

As a result of the determination described above, if the values of the registers holding the battery voltage are “zero” (YES), a battery exchange is recognized to have been carried out, and control proceeds to an engine start prompting routine (step S107) as described later. On the other hand, if the values of the registers holding the battery voltage are not “zero” (NO), control returns to the battery managing operation routine shown in FIG. 2. The remaining battery managing operation routine is described later.

In the two battery exchange detecting subroutines described above, battery exchange is detected by determining whether or not a resetting operation has been performed, or by determining whether or not the values of the registers holding the battery voltage V are “zero”. However, the ways of detection may not be limited to these subroutines described herein. For example, an arrangement may be made, in which battery exchange is detected by detecting a battery voltage that has been reduced to not more than a predetermined threshold value.

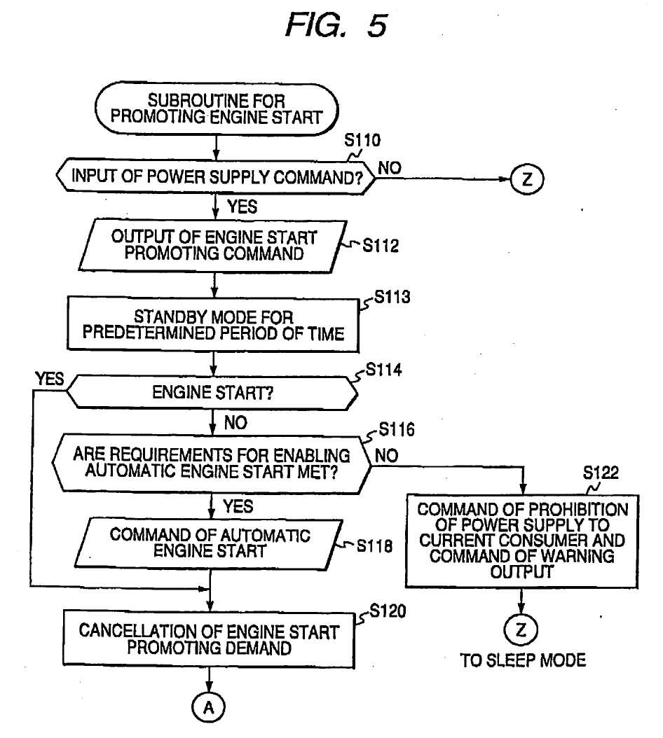

The engine start prompting routine mentioned above is now described with reference to the flow diagram illustrated in FIG. 5.

First, a determination is made as to whether or not the vehicle ECU 50 has inputted an interrogation on the possibility of power supply (hereinafter simply referred to as a “power supply command”) to a current consumer which consumes power of more than a certain level (step S110). Note that this power supply command may be received, not from the vehicle ECU 50 that controls the entire vehicle, but from a power managing ECU which controls power management of only a vehicle.

To describe further on the power supply command, these ECU's perform as follows. Specifically, when a switching operation is performed, automatically or manually, in an engine-stop state to turn on a current consumer, the ECU's input the power supply command to interrogate the microcomputer 4 for managing battery as to whether or not power supply is possible. Based on the responsive information from the microcomputer 4 on the possibility/impossibility of the power supply, power supply to the current consumer is made possible only when the microcomputer 4 has allowed the power supply.

If the power supply command has not been inputted at step S110 (NO), the microcomputer 4 enters into a sleep mode described later. If the power supply command has been inputted (YES), the microcomputer 4 outputs an engine start prompting demand to the vehicle ECU 50 (step S112).

Note that this engine start prompting demand does not mean that the engine start prompting command is actually given to the vehicle ECU 50, but means that information or warning is given to a vehicle occupant, so that the occupant can start engine immediately after battery exchange. This information or warning is given by known optical or sonic means or by communication means, such as a cellular phone.

Subsequently, control enters into a standby mode lasting for a predetermined period of time (step S113), and then a determination is made as to whether or not an engine start has been performed (step S114). As a result, if an engine start has been performed (YES), control proceeds to step S120 where the engine start prompting demand is withdrawn. Contrarily, if an engine start has not been performed (NO), control proceeds to step S116 where a determination is made as to whether or not requirements for enabling automatic engine start are met (step S118). The requirements for enabling automatic engine start include, for example, whether or not a predetermined period of time has passed from the determination on battery exchange, and whether or not the gear has been shifted to parking position. These are the same as the normal requirements for automatic engine start.

If the requirements for automatic engine start are determined to be met at step S116 (YES), control proceeds to S118 where optical or sonic commanding of automatic engine start is given inside the vehicle. Then, a command for the automatic engine start is given to the vehicle ECU 50 (step S118), followed by withdrawing the engine start prompting demand (step S120).

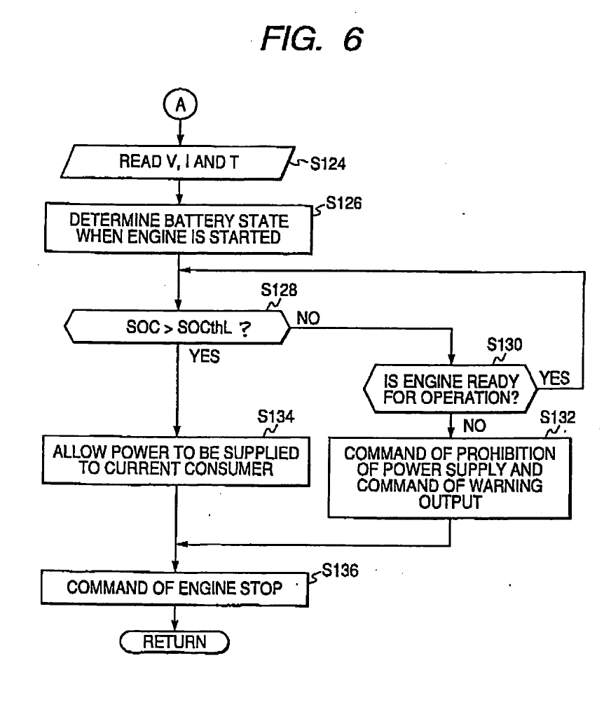

On the other hand, if the requirements for automatic engine start are determined not to be met at step S116 (NO), control proceeds to step S122 where prohibition of power supply to the current consumer is determined, and then a warning is given accordingly to the vehicle ECU 50. Then, control enters into a sleep mode. Note that the warning mentioned above may preferably be made by sonic guidance. When the engine start prompting demand is cancelled at step S120, control proceeds to a routine, shown in FIG. 6, for detecting battery state quantity at the engine start.

With reference to the flow diagram illustrated in FIG. 6, description on the routine for detecting battery state quantity at the engine start is provided hereunder.

The sensor side power blocking switch 7 is switched on first, followed by a standby mode for a short time, which continues until the output power supply voltage of the sensor power circuit 6 is stabilized. During engine start, an engine start battery state quantity consisting of a battery voltage V, a current I and a temperature T, is read in (step S124).

Then, a predetermined electrical quantity that specifically represents the engine start battery state is computed from the engine start battery state quantity that has been read in. The engine start battery state is determined based on the computed electrical quantity (step S126).

In the present embodiment, data pairs each consisting of the battery voltage V and the discharge current (engine start current) I are sampled at a plurality of different points during an engine start period to have them served as the engine start battery state quantity. In the present embodiment, the electrical quantity is to include an internal resistance and an open voltage of the in-vehicle battery 20, which have been computed from the data pairs.

Note that, for the operation for obtaining the internal resistance (battery resistance) and the discharge voltage of the in-vehicle battery 20 from the plurality of data pairs, a well-known formula is used, but that, as the formula does not constitute per se a principal part of the present invention, description on the details of the operation is omitted.

Further, in the present embodiment, the following are obtained based on the computed internal resistance and the open voltage by using a known formula or a map. That is, a residual capacity (SOC) of a battery or an electrical quantity correlated thereto, and a deterioration degree of a battery or an electrical quantity correlated thereto are obtained. Again, since computation of the residual capacity (SOC) and the deterioration degree of a battery based on the internal resistance and the discharge voltage, is well known and does not constitute a principal part of the present invention, description therefor is omitted.

Then, a determination is made as to whether or not the obtained residual capacity (SOC) is larger than a predetermined low residual capacity threshold (SOCthL) (step S128). Note that the low residual capacity threshold (SOCthL) is set to be larger than “electrical quantity at least ensuring the subsequent engine start+predetermined margin”.

If the residual capacity (SOC) is equal to or less than the low residual capacity threshold (SOCthL) at step S128 (NO), a determination is made as to whether or not requirements for engine operation duration, such as fuel quantity, have been met (step S130). As a result, if the engine operation duration requirements are met (YES), control returns to step S128 where engine operation is continued to further charge the in-vehicle battery 20. On the other hand, if the engine operation duration requirements are not met at step S130 (NO), a command for prohibiting power supply to a current consumer is transmitted to the vehicle ECU 50 (step S132), and control proceeds to step S136′.

At step S128, if the residual capacity (SOC) exceeds the low residual capacity threshold (SOCthL) (YES), this means that the residual capacity (SOC) of the in-vehicle battery 20 has been ensured. Therefore, power supply to the current consumer is allowed (step S134), and control proceeds to step S136.

At step S136, in case of an automatic operation, a command is given to the vehicle ECU 50 to stop the engine. In case of a manual operation, a command is given to the vehicle ECU 50 to enable engine stop upon off-operation of an ignition switch by a driver. Then, the engine start prompting routine and the routine for detecting engine start battery state quantity, are terminated.

The remaining of the battery managing operation described 6 above is further described hereunder referring again to the flow diagram illustrated in FIG. 2.

The sensor side power blocking switch 7 is turned on first (step S140). This allows the sensor power circuit 6 to supply constant voltage power of high precision to the external sensor 1, the voltage detection circuit 2 and the A/D converter 3.

Then, after a short standby period for stabilizing the operation conditions of the external sensor 1, the voltage detection circuit 2 and the A/D converter 3, detection is performed on the battery voltage V, the charge and discharge current I and the battery temperature T of the in-vehicle battery 20 (step S142).

Subsequently, a sampling period □tr from the previous reading point to the present reading point of the charge and discharge current I, is multiplied by the current I to compute a present integrated value I□tr. The present integrated value I□tr is added to a cumulative discharge capacity of the past which is stored in a cumulative register of its own, or is subtracted from the residual capacity (SOC) to provide a present cumulative discharge capacity or a present residual capacity (SOC) (step S144).

Then, predetermined other routines are executed (step S146). The other routines include a routine for determining whether or not the battery temperature T is in a predetermined range, a routine for detecting the battery voltage V at engine start and determining a discharge capacity at a high current of the battery based on the engine start battery voltage V, a routine for determining overcharge and over-discharge based on the battery voltage V and the charge and discharge current I, a routine for determining a full charge state and a complete discharge state in order to cancel a current integration error, and a routine for transmitting a computed residual capacity of the in-vehicle battery 20 to an external ECU. As these routines do not constitute a principal part of the present embodiment, descriptions therefor are omitted.

Then, checking is performed as to whether or not a power supply command is received from the vehicle ECU 50 (step S148). As a result, if a power supply command is received (YES), control returns to step S142 where current integration is continued. Contrarily, if there is no power supply command (NO), a determination is made whether or not an ignition switch has been turned off (step S150). As a result, if the ignition switch has not been turned off (NO), control returns to step S142 where current integration is continued. Contrarily, if the ignition switch has been turned off (YES), the sensor side power blocking switch 7 is turned off (step S152), and control enters into a sleep mode.

In the present embodiment, a residual capacity of the in-vehicle battery 20 obtained by the current integration of the in-vehicle battery 20 is to be retained even in a sleep mode (described later) which is executed after the ignition switch has been turned off. However, as a matter of course, the obtained residual capacity may be stored in a non-volatile memory or the like. This is only a matter of design which may be changed appropriately.

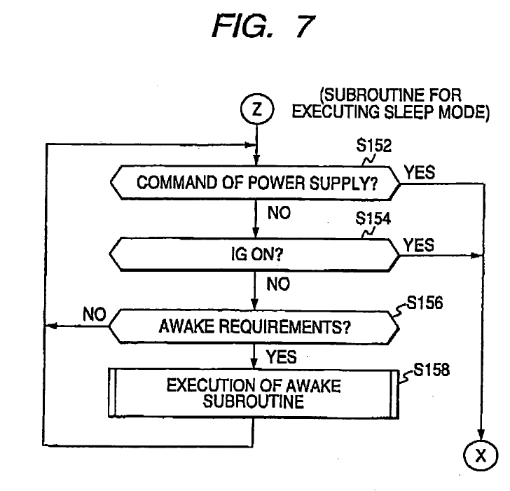

Hereinafter, a routine for executing the sleep mode mentioned above is described with reference to the flow diagram illustrated in FIG. 7.

In the sleep mode, clock frequency of the microcomputer 4 is reduced to reduce its power consumption. Alternatively, in the sleep mode, the microcomputer 4 may command the microcomputer power circuit 5 to reduce its output voltage within a range not detrimental to the operation of the microcomputer 4, so that electricity is further saved. Alternatively, among the individual circuits in the microcomputer 4, the internal registers and memories which are not required for executing the sleep mode, may be stopped from being supplied with power.

In the sleep mode, it is determined whether or not a power supply command has been received from the in-vehicle ECU50 (step S152). As a result, if a power supply command has been received (YES), control is returned to step S140 shown in FIG. 2 to terminate the sleep mode.

On the other hand, if a power supply command has not been received at step S152 (NO), a determination is made, by using an external signal, as to whether or not the ignition switch has been turned on (step S154). As a result, if the ignition switch has been turned on (YES), control returns to step S140 to terminate the sleep mode. Contrarily, if the ignition switch has been turned off (NO), a determination is made whether or not predetermined awake requirements have been caused (step S156). As a result, if the awake requirements have been caused (YES), a predetermined awake mode executing routine is executed (step S158). If not caused (NO), control returns to step S152 to maintain the sleep mode.

Note that, when it is referred to that “the predetermined awake requirements have been caused”, it means that the results of the determinations have been satisfied, which determinations are made on the basis of a predetermined external signal inputted to the microcomputer 4 and a predetermined determination signal detected or computed by the microcomputer 4. As the awake requirements do not constitute a principal part of the present embodiment, description on their specific examples is omitted. Further, the “awake mode” mentioned above is for starting up the microcomputer 4 periodically or with predetermined awake requirements to permit it to perform predetermined operations. However, as this mode does not constitute a principal part of the present embodiment, description therefor is omitted.

As described above, according to the present embodiment, the following effects are obtained.

As described above, a voltage value at engine start is indispensable for computing a correct battery state quantity (e.g., a residual capacity (SOC) and a deterioration degree) because the voltage value is less affected by the battery polarization voltage. In the present embodiment, a command for prompting engine start is outputted by automatically detecting battery exchange. This enables early elimination of adverse effects caused by battery exchange, i.e. the loss of engine start battery state quantity from a battery managing circuit, or the storage of incorrect values as the engine start battery state quantity.

When a current consumer is used after battery exchange and before obtaining the engine start battery state quantity to thereby reduce the residual capacity (SOC) of a battery, the battery may be exhausted, disabling the subsequent engine start. However, according to the present embodiment, a current consumer is prohibited from being used after battery exchange and before the subsequent engine start, whereby the disadvantage may be reduced.

Moreover, this prohibition of using the current consumer is advantageous because it may serve as means for giving warning to a driver so that the driver can prompt engine start. As a matter of course, specifically important current consumers may be exempt from the prohibition of use.

Additionally, when a battery has been detected as being exchanged, only a warning may be given to prompt engine start, without prohibiting use of current consumers.

Further, in the present embodiment, in case an engine is not started by a driver after battery exchange, automatic engine start has been performed after confirming engine start as being possible. However, the automatic engine start may be omitted.

In the present embodiment, a simple circuit may ensure detection of battery exchange because the battery exchange can be detected by detecting reduction of a battery voltage, which accompanies battery exchange.

In the present embodiment, a residual capacity of an in-vehicle battery has been determined based on the determination on the conditions of the in-vehicle battery at engine start, and in case the residual capacity is equal to or less than a predetermined level, a predetermined operation for encouraging engine operation prolongation has been performed. Thus, if the high precision residual capacity of a battery obtained from the engine start battery state quantity is less than an electrical quantity required for the subsequent engine start, engine prolongation is encouraged, thereby preventing a possible error in the subsequent engine start.

However, there may be seriousness in the deterioration conditions of an in-vehicle battery, which have been determined based on the results of determination on the in-vehicle battery conditions at engine start. In such a case, it is preferable to stop the operation for encouraging engine operation prolongation. This may enable to avoid failure of prolonging engine operation in a condition where no improvement may be expected in the battery discharge conditions by the prolongation. Note that in case there is seriousness in the deterioration conditions of an in-vehicle battery, which have been determined based on the results of determination on the in-vehicle battery conditions at engine start, it may be preferable to give a warning accordingly.

(Modifications)

Note that the embodiment described above has been implemented in association with an engine-driven vehicle, however, it may be implemented in association with a hybrid vehicle in a similar manner. In case of a fuel cell powered vehicle as well, an electrical quantity of a specific level is required at the time of starting the fuel cell. Thus, the technical concept described above may be utilized in exchanging a secondary battery which is supplementarily loaded on a fuel cell powered vehicle. In this case, however, the “engine start” In the embodiment described above should be replaced by “fuel cell operation”.

The warning for prompting engine start described above may be given by a meter indication, a luminous indication or an audio indication, or by transmitting a message to a cellular phone of a driver, which has been registered in advance. In addition, when a command is given by a battery managing circuit to inhibit power supply to a current consumer, followed by a driver's re-operation for using the current consumer, the driver's operation may be prioritized.

In the embodiment described above, a residual capacity (SOC) has been obtained based on an engine start battery state quantity after battery exchange. Instead, determination on the deterioration degree of the exchanged in-vehicle battery 20 may be utilized. The deterioration degree may be determined based, for example, on a battery resistance.

For the sake of completeness, it should be mentioned that the various embodiments explained so far are not definitive lists of possible embodiments. The expert will appreciates that it is possible to combine the various construction details or to supplement or modify them by measures known from the prior art without departing from the basic inventive principle.

What is claimed is:

1. An apparatus for managing a state of an in-vehicle battery including in a power supply for use in a vehicle in which an engine is mounted, comprising:
determining means for determining whether or not the in-vehicle battery is exchanged to a new in-vehicle battery; and
promoting means for performing a predetermined promoting operation promoting a start of the engine after exchanging the in-vehicle battery, in cases where it is determined that the in-vehicle battery has been exchanged.

2. The apparatus according to claim 1, further comprising
detecting means for detecting a signal indicating the state of the in-vehicle battery when the engine is started;
estimating means for estimating the state of the in-vehicle battery based on the detected electric signal;
managing means for managing the state of the in-vehicle battery based on a result estimated by the estimating means.

3. The apparatus according to claim 2, wherein
the determining means is configured to detect the exchange of the in-vehicle battery by detecting a condition where a battery voltage across the in-vehicle battery decreases lower than a predetermined threshold of the battery voltage, and
the promoting means is configured to perform the promoting operation when the exchange of the in-vehicle is determined.

4. The apparatus according to claim 2, further comprising:
calculating means for calculating a value corresponding to a battery resistance of the in-vehicle battery or a functional value whose variable is the battery resistance, based on the detected signal indicating the state of the in-vehicle battery when the engine is started; and
deciding means for deciding a state showing a residual capacity of the in-vehicle battery using the calculated value.

5. The apparatus according to claim 1, wherein
the promoting means comprising command means for commanding a start of the promoting operation and commanding an end of the promoting operation when the engine has been started after commanding the start of the promoting operation.

6. The apparatus according to claim 5, wherein the command means is configured to determine whether or not a command of supplying power to a predetermined current consumer is issued when the in-vehicle battery is exchanged and to command a start of the promoting operation when the command of supplying the power is issued.

7. The apparatus according to claim 1, wherein the promoting operation is an output of either informing or warning to promote the start of the engine.

8. The apparatus according to claim 1, wherein the promoting operation is an operation to start the engine under predetermined engine automatic start requirements.

9. The apparatus according to claim 1, wherein the promoting operation includes, as a first operating, outputting either informing or warning to promote the start of the engine and, as a second operation succeeding to the first operation, making the engine start in cases where the engine has not been started within a predetermined period of time after either the informing or warning and predetermined engine automatic start requirements are met.

10. The apparatus according to claim 9, wherein the promoting operation further includes prohibiting power to a current consumer on the vehicle when the engine automatic start requirements are met and outputting either informing or warning showing prohibiting the supply of the power.

11. The apparatus according to claim 1, further comprising:
means for determining whether or not a residual capacity of the in-vehicle battery is lower than a predetermine level, on the basis of the state of the in-vehicle battery estimated when the engine is started; and
means for performing a promoting operation for prolonging a predetermined operation of the engine when it is determined that the residual capacity of the in-vehicle battery is lower than a predetermine level.

12. The apparatus according to claim 11, wherein the promoting operation for prolonging a predetermined operation of the engine is an operation for either informing or warning to prevent the engine from stopping.

13. The apparatus according to claim 11, wherein the promoting operation for prolonging a predetermined operation of the engine is an operation for stopping the operation of the engine.

14. The apparatus according to claim 11, further comprising:
means for stopping the promoting operation for prolonging the predetermined operation of the engine in response to a deteriorated state of the in-vehicle battery found from the state of the in-vehicle battery estimated when the engine starts.

15. An apparatus for managing a state of an in-vehicle battery including in a power supply for use in a vehicle in which an engine is mounted, comprising:
means for determining whether or not a residual capacity of the in-vehicle battery is lower than a predetermine level, on the basis of the state of the in-vehicle battery estimated when the engine is started; and
means for performing a promoting operation for prolonging a predetermined operation of the engine when it is determined that the residual capacity of the in-vehicle battery is lower than a predetermine level.

16. A method of managing a state of an in-vehicle battery including in a power supply for use in a vehicle in which an engine is mounted, comprising steps of:
determining whether or not the in-vehicle battery is exchanged to a new in-vehicle battery; and
performing a predetermined promoting operation for promoting an engine start after exchanging the in-vehicle battery, in cases where it is determined that the in-vehicle battery has been exchanged.

17. An apparatus for managing a state of an in-vehicle battery including in a power supply for use in a vehicle in which an engine is mounted, comprising:
a determining unit configured to determine whether or not the in-vehicle battery is exchanged to a new in-vehicle battery; and
a promoting unit configured to perform a predetermined promoting operation promoting a start of the engine after exchanging the in-vehicle battery, in cases where it is determined that the in-vehicle battery has been exchanged.

18. The apparatus according to claim 17, further comprising
a detector configured to detect a signal indicating the state of the in-vehicle battery when the engine is started;
an estimator configured to estimate the state of the in-vehicle battery based on the detected electric signal;
a managing unit configured to manage the state of the in-vehicle battery based on a result estimated by the estimator.

19. The apparatus according to claim 18, wherein
the determining unit is configured to detect the exchange of the in-vehicle battery by detecting a condition where a battery voltage across the in-vehicle battery decreases lower than a predetermined threshold of the battery voltage, and
the promoting unit is configured to perform the promoting operation when the exchange of the in-vehicle is determined.

20. The apparatus according to claim 18, further comprising:
a calculator configured to calculate a value corresponding to a battery resistance of the in-vehicle battery or a functional value whose variable is the battery resistance, based on the detected signal indicating the state of the in-vehicle battery when the engine is started; and
a deciding unit configured to decide a state showing a residual capacity of the in-vehicle battery using the calculated value.
